(19) United States
(12) Patent Application Publication
(10) Pub. No.: US 2021/0176160 A1
(43) Pub. Date: Jun. 10, 2021

(54) METHOD AND DEVICE FOR SYNCHRONIZING NODE OF BLOCKCHAIN

(71) Applicant: BEIJING KINGSOFT INTERNET SECURITY SOFTWARE CO., LTD., Beijing (CN)

(72) Inventors: Wenyu Yang, Beijing (CN); Chunmeng Gao, Beijing (CN)

(73) Assignee: BEIJING KINGSOFT INTERNET SECURITY SOFTWARE CO., LTD., Beijing (CN)

(21) Appl. No.: 16/770,757

(22) PCT Filed: Jan. 22, 2019
(86) PCT No.: PCT/CN2019/072716

§ 371 Date: Jun. 8, 2020

(30) Foreign Application Priority Data
Jun. 29, 2018 (CN) 201810713057.4

(51) Int. Cl. H04L 12/751; H04L 12/721; H04L 29/08; H04L 29/06

(52) U.S. Cl. CPC H04L 45/02; H04L 67/42; H04L 67/1095; H04L 45/44

(57) ABSTRACT

A method and a device for synchronizing a node of a blockchain includes: acquiring information of a plurality of nodes adjacent to a node to be synchronized, and information of a plurality of nodes adjacent to an XOR node of the node to be synchronized, and determining candidate nodes according to the acquired information of the nodes; selecting a first predefined number of nodes from the candidate nodes as a newly added node; updating, according to information of the newly added node, a routing table of the node to be synchronized, to obtain an updated routing table; and synchronizing, according to the updated routing table, the node to be synchronized.

### CROSS-REFERENCE TO RELATED APPLICATIONS

This application claims priority to and benefits of Chinese Patent Application No. 201810713057.4, filed with the State Intellectual Property Office of P. R. China on Jun. 29, 2018 by BEIJING KINGSOFT INTERNET SECURITY SOFTWARE CO LTD., titled “Method and Device for Synchronizing BlockChain Nodes”.

### FIELD

The present disclosure relates to a field of computer applications and blockchain technologies, and more particularly, to a method and a device for synchronizing blockchain nodes.

### BACKGROUND

Currently, blockchain platforms mainly include Bitcoin platform and Ethereum platform. The Ethereum platform expands the first generation of encrypted digital currencies into programmable currencies, and supports third-party developers to develop smart contract applications and issue digital tokens in their platforms, thereby greatly expanding application scenarios of the blockchain. Currently, the Ethereum platform has become the most popular public chain system in the blockchain industry.

An important feature of the blockchain is that block information of the entire blockchain is stored at each node. Therefore, block data of all nodes of the entire platform needs to be updated synchronously. In the Ethereum platform, a new block is generated every 10 seconds. Compared to the Bitcoin platform, which generates a block every 10 minutes, a higher updating efficiency of the block data is required. Currently, the number of nodes on the Ethereum platform is about 100,000 orders of magnitude and is constantly growing. Meanwhile, transaction volume is also increasing with the popularity of blockchain technologies, resulting in continuous increase of the capacity of each block within an allowable range, which brings great challenges to efficient synchronization among the nodes of the blockchain.

Currently, network layers of the Ethereum system use the Kademelia P2P communication protocol based on Distributed Hash Table (DHT). DHT is a distributed storage method. When no server is required, each client is responsible for a small range of rout and is responsible for storing a small portion of data, so as to achieve addressing and storage of an entire DHT network. In this protocol, a routing table maintained by each node is composed of 17 buckets, and each bucket contains 16 nodes. The total number of nodes in the routing table does not exceed 17*16. During the synchronization process, a total difficulty (TD) value of a blockchain in the block data of each node in the routing table is obtained in sequence. The higher the TD value, the higher the height of the blockchain contained in the node, that is, the larger the number of blocks contained in the node. According to the TD value of each node, new block data is obtained from the node with the highest TD value to complete the synchronization.

In the communication protocol of Ethereum, by default, the routing table of a node is determined based on an ID (identity) of the node. When the ID of the node is constant, the routing table of the node is roughly constant. Therefore, a failure often occurs in a synchronization for the node when a network status of an adjacent node of the current node is not good, such as when the network is frequently disconnected or the network throughput capacity is limited. Once the synchronization is failed, a transaction status of the current node is not up-to-date, which brings great security problems. Therefore, the node synchronization strategy needs to be improved.

### SUMMARY

Embodiments of the present disclosure aim to solve at least one of the technical problems in the related art, improve a blockchain node synchronization strategy, and provide a method and a device for synchronizing blockchain nodes.

In order to achieve the above objects, embodiments of a first aspect of the present disclosure provide a method for synchronizing blockchain nodes. The method includes: obtaining information of a plurality of first nodes adjacent to a node to be synchronized and information of a plurality of second nodes adjacent to an XOR node of the node to be synchronized, and determining candidate nodes according to the information of the plurality of first nodes and the information of the plurality of second nodes, in which the XOR node of the node to be synchronized refers to a node whose node identifier is an XOR value of a node identifier of the node to be synchronized; selecting a first predefined number of nodes from the candidate nodes as new nodes; updating a routing table of the node to be synchronized according to information of the new nodes to obtain an updated routing table; and synchronizing the node to be synchronized according to the updated routing table.

In some embodiments, obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, includes: sending a node search request to each node in the routing table of the node to be synchronized, in which the node search request includes: requesting a target node to return information of M first nodes closest to the node to be synchronized to the routing table, and requesting the target node to return information of M second nodes closest to the XOR node of the node to be synchronized to the routing table, where M is a predefined positive integer; obtaining information returned by each node in the routing table; and determining the candidate nodes according to the information returned by each node in the routing table.

In some embodiments, sending the node search request to each node in the routing table of the node to be synchronized, includes: starting to time after sending the node search request; and in response to that a timing result reaches a first predefined time period, stopping sending the node search request.

In some embodiments, obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, includes: obtaining information of all nodes from a global routing table containing all nodes of a blockchain system and stored by the node to be synchronized, in which the global routing table includes a node identifier, a node internet protocol address and current status information of each node of a blockchain network; determining information of M first nodes closest to the node to be synchronized among all the nodes and information of M second nodes closest to the XOR node of the node to be synchronized according to the information of all nodes, in which M is a predefined positive integer; and determining the M first nodes closest to the node to be synchronized and the M second nodes closest to the XOR node of the node to be synchronized as the candidate nodes.

In some embodiments, the method further includes: updating the global routing table every second predefined time period to obtain latest node information.

In some embodiments, selecting the first predefined number of nodes from the candidate nodes as the new nodes, includes: according to a total difficulty value of a blockchain stored in each candidate node, selecting the first predefined number of nodes each with a highest total difficulty value as the new nodes.

In some embodiments, synchronizing the node to be synchronized according to the updated routing table, includes: obtaining a total difficulty value of a blockchain stored in each node of the updated routing table; determining a node with a highest total difficulty value as a target synchronization node; and synchronizing blockchain data of the node to be synchronized according to the target synchronization node.

Compared with existing node updating methods, with the method for synchronizing blockchain nodes according to the present disclosure, more node information can be obtained, and the most ideal node can be selected from more nodes for synchronization and routing table update, thus the effect of synchronization reaches local optimum. In this way, the node may obtain currently confirmed or forked transactions faster and more stably, thereby ensuring the security and reliability of ledger records. Meanwhile, the routing table of the node is optimized.

In order to achieve the above objects, embodiments of a second aspect of the present disclosure provide a device for synchronizing blockchain nodes. The device includes: a candidate node obtaining module, configured to obtain information of a plurality of first nodes adjacent to a node to be synchronized and information of a plurality of second nodes adjacent to an XOR node of the node to be synchronized, and determine candidate nodes according to the information of the plurality of first nodes and the information of the plurality of second nodes, in which the XOR node of the node to be synchronized refers to a node whose node identifier is an XOR value of a node identifier of the node to be synchronized; a new node selecting module, configured to select a first predefined number of nodes from the candidate nodes as new nodes; a routing table updating module, configured to update a routing table of the node to be synchronized according to information of the new nodes to obtain an updated routing table; and a node synchronizing module, configured to synchronize the node to be synchronized according to the updated routing table.

In some embodiments, the candidate node obtaining module includes: a node searching unit, configured to send a node search request to each node in the routing table of the node to be synchronized, in which the node search request includes: requesting a target node to return information of M first nodes closest to the node to be synchronized to the routing table, and requesting the target node to return information of M second nodes closest to the XOR node of the node to be synchronized to the routing table, in which M is a predefined positive integer; an information receiving unit, configured to obtain information returned by each node in the routing table; and a candidate node determining unit, configured to determine the candidate nodes according to the information returned by each node in the routing table.

In some embodiments, the node searching unit is further configured to: start to time after sending the node search request; and in response to that a timing result reaches a first predefined time period, stop sending the node search request.

In some embodiments, the device for synchronizing blockchain nodes further includes a global routing table, the global routing table includes a node identifier, a node internet protocol address and current status information of each node of a blockchain network. The candidate node obtaining module includes: a global node obtaining unit, configured to obtain information of all nodes from the global routing table, an adjacent node computing unit, configured to determine information of M first nodes closest to the node to be synchronized among all the nodes and information of M second nodes closest to the XOR node of the node to be synchronized according to the information of all nodes, in which M is a predefined positive integer; and a candidate node determining unit, configured to determine the M first nodes closest to the node to be synchronized and the M second nodes closest to the XOR node of the node to be synchronized as the candidate nodes.

In some embodiments, the device for synchronizing blockchain nodes further includes a global routing table updating module, configured to update the global routing table every second predefined time period to obtain latest node information.

In some embodiments, the new node selecting module selects the first predefined number of nodes from the candidate nodes as the new nodes by: according to a total difficulty value of a blockchain stored in each candidate node, selecting the first predefined number of nodes each with the highest total difficulty value as the new nodes.

In some embodiments, the node synchronizing module synchronizes the node to be synchronized according to the updated routing table, by: obtaining a total difficulty value of a blockchain stored in each node of the updated routing table; determining a node with a highest total difficulty value as a target synchronization node; and synchronizing blockchain data of the node to be synchronized according to the target synchronization node.

Compared with existing node updating methods, with the device for synchronizing blockchain nodes according to the present disclosure, more node information can be obtained, and the most ideal node can be selected from more nodes for synchronization and routing table update, thus the effect of synchronization reaches local optimum. In this way, the node may obtain currently confirmed or forked transactions faster and more stably, thereby ensuring the security and reliability of ledger records. Meanwhile, the routing table of the node is optimized.

In order to achieve the above objects, embodiments of a third aspect of the present disclosure provide a non-transitory computer-readable storage medium having a computer program stored thereon, when the computer program is executed by a processor, the method for synchronizing blockchain nodes according to embodiments of the first aspect is implemented.

In order to achieve the above objects, embodiments of a fourth aspect of the present disclosure provide a computer program product, when instructions in the computer program product are executed by a processor, the method for synchronizing blockchain nodes according to embodiments of the first aspect is implemented.

In order to achieve the above objects, embodiments of a fifth aspect of the present disclosure provide a computing device including a memory, a processor, and a computer program stored on the memory and executable on the processor, when the computer program is executed by the processor, the method for synchronizing blockchain nodes according to embodiments of the first aspect is implemented.

The non-transitory computer-readable storage medium according to the third aspect of the present disclosure, the computer program product according to the fourth aspect of the present disclosure and the computing device according to the fifth aspect of the present disclosure, have similar beneficial effects as the method for synchronizing blockchain nodes according to the first aspect of the present disclosure and the device for synchronizing blockchain nodes according to the second aspect of the present disclosure, which will be not repeated herein.

### BRIEF DESCRIPTION OF THE DRAWINGS

The above and/or additional aspects and advantages of the present disclosure will become apparent and easily understood from the following description of the embodiments with reference to the accompanying drawings, in which:

FIG. 1 is a schematic diagram of a communication mode at a network layer of a blockchain system.

FIG. 2 is a flowchart of a method for synchronizing blockchain nodes according to an embodiment of the present disclosure.

FIG. 3 is a schematic diagram of a return result queried by a node in a routing table according to an embodiment of the present disclosure.

FIG. 4 is a schematic diagram of a selection of candidate nodes according to an embodiment of the present disclosure.

FIG. 5 is a block diagram of a device for synchronizing blockchain nodes according to an embodiment of the present disclosure.

FIG. 6 is a schematic diagram of a computing device according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and illustrative, not construed to limit the present disclosure.

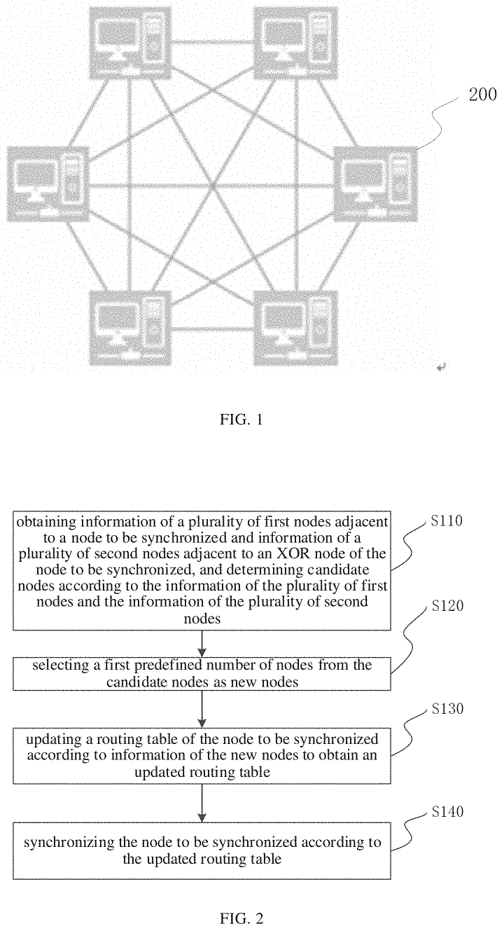

FIG. 1 is a schematic diagram of a network communication mode of a blockchain system. Each node 200 is connected to each other through the Internet. Generally, the blockchain system uses a peer-to-peer (P2P) network technology to connect peer nodes to form a network, thereby forming a decentralized network structure. For example, Ethereum blockchain system uses a Kademelia P2P communication protocol based on a distributed hash table (DHT) at the network layer to achieve communication among nodes.

In the DHT protocol, each node has a globally unique identifier “node ID”. As a decentralized distribution network structure, in the case of a serverless network, in a default setting, each node maintains its own small-scale routing table, and performs node synchronization and data transmission according to the node's routing table.

For example, in a setting for Ethereum Kademelia protocol, a routing table maintained by each node is composed of 17 buckets, and each bucket contains 16 nodes. The total number of nodes in the routing table does not exceed 17*16. During the synchronization process, the node obtains a total difficulty (TD) value of a blockchain in block data of each node in the routing table in sequence. The higher the TD value, the higher the height of the blockchain contained in the node, that is, the larger the number of blocks contained in the node. According to the TD value of each node, a node with the maximum TD value is determined as a target node, and new block data is obtained from the target node to complete the synchronization.

When the node wants to initialize the routing table, a request to query its own node is sent to a bootnode, for example, using a command “findnode (selfId, bootnode)”. Whenever a node receives the “findnode” request, information of a specified number of nodes (for example, M=16*17) closest to the query initiating node ID is returned to the query initiating node. That is, in the initialization phase, a node can find M nodes closest to itself starting from the bootnode, and use the M nodes as nodes in the routing table.

In the Kademelia protocol, a distance between two nodes is defined by obtaining an XOR value of two node IDs using XOR calculation based on the node IDs and converting the XOR value to an unsigned integer. For example, for two nodes having respective node IDs as A and B, the distance between two nodes is defined as distance (A, B)=IA xor BI, and the smaller the distance, the closer the two nodes.

Therefore, once the node ID is determined, the routing table formed of adjacent nodes calculated based on the node ID rarely changes. However, if a network status of the adjacent node of the current node is not good, such as when the network is frequently disconnected or the network throughput is limited, the synchronization failure often occurs. Once the synchronization is failed, a transaction status of the current node is not up-to-date, which brings great security issues.

To solve problems of instability and low efficiency in the synchronization process using the existing node synchronization methods, the present disclosure provides a method for synchronizing blockchain nodes that dynamically updates a routing table based on an enlarge queried node range and performs node synchronization based on the updated routing table. By obtaining nodes closest to the current node or an XOR node of the current node, appropriate nodes are selected therefrom to update the routing table. In this way, optimum nodes are selected from more nodes for synchronization, so as to achieve local optimum of selection of nodes for the synchronization.

The method and the device for synchronizing blockchain nodes according to the embodiments of the present disclosure are described in detail below with reference to the drawings.

When a new node of the blockchain is enabled, the node is connected to an initial bootnode of the blockchain and an initial routing table is obtained from the initial bootnode.

The initial bootnode can be determined in a preset manner. For example, when a new node of the Ethereum blockchain is enabled, the initial bootnode can be a node provided by Ethereum, for example:

“enode://a979fb575495b8d6db44f750317d0f4622bf4c2aa3365d6af7c284339968eef29b69a d0dce72a4d8db5ebb4968de0e3bec910127f134779fbcbOcb6d3331163c@ 52.16.188.185:30303”).

Specifically, according to the Kademelia protocol, when the node wants to initialize the routing table, a request to query its own node is sent to a bootnode, for example, using a command “findnode (selfId, bootnode)”. Whenever the bootnode receives a “findnode” request, information of the specified number of nodes closest to the query initiating node ID is returned to the query initiating node. That is, in the initialization phase, a node can find a plurality of nodes closest to itself starting from the bootnode, and use the plurality of nodes as nodes in the routing table. Generally, the number of such nodes can be 10, 15, and so on. After the routing table is initialized, the routing table is maintained by each node. Good nodes can be continuously added to the routing table or bad nodes can be removed. For specific methods, reference may be made to related literatures of the blockchain in the related art, which is not be repeated here.

After the initialization, each time a node needs to be synchronized, it selects the node with the highest TD value (the total difficulty value of the blockchain stored by the node) from the nodes in its own routing table as a target synchronization node, and performs synchronization on blockchain information according to the target synchronization node. According to the Kademelia protocol, by default, the maximum number of nodes in a routing table is 16*17=272, and when the node ID is constant, the nodes in the routing table rarely vary. As the number of nodes in the blockchain system increases, for example, the number of Ethereum blockchain nodes has reached 100,000 orders of magnitude, which is still increasing, only querying the TD values of the nodes in the routing table for node synchronization brings limitations on synchronization efficiency, and the latest confirmed transactions or forked transactions cannot be obtained in a timely manner.

Therefore, the present disclosure improves an update strategy of the routing table and a selection mechanism of nodes for synchronization, and obtains the node with the highest TD value from a set of more nodes for synchronization.

FIG. 2 is a flowchart of a method for synchronizing blockchain nodes according to an embodiment of the present disclosure. The method includes steps at blocks S110 to S140.

At block S110, information of a plurality of first nodes adjacent to a node to be synchronized and information of a plurality of second nodes adjacent to an XOR node of the node to be synchronized are obtained, and candidate nodes are determined according to the information of the plurality of first nodes and the information of the information of a plurality of second nodes, in which the XOR node of the node to be synchronized refers to a node whose node identifier is an XOR value of a node identifier of the node to be synchronized.

The adjacent nodes are determined from a definition of the distance between the two nodes in the Kademelia protocol and the DHT system. The smaller the distance between the nodes, the closer the two nodes are. In the field of blockchain, when it comes to the distance between nodes, the distance between the nodes determined based on the result of the XOR operation on the node IDs is generally used. Therefore, in the present disclosure, unless specified or limited otherwise, the distance between each two nodes can adopt the definition of distance between the nodes in the Kademelia protocol and the DHT system, that is, the distance determined according to the XOR operation on the node IDs.

In some embodiments, the information of the plurality of first nodes adjacent to the node to be synchronized and the information of the plurality of second nodes adjacent to the XOR node of the node to be synchronized may be obtained by each node in the routing table of the node to be synchronized.

Specifically, a node search request may be sent to each node in the routing table of the node to be synchronized. The node search request includes: requesting a target node to return information of M first nodes that are closest to the node to be synchronized to the routing table, and requesting the target node to return information of M second nodes that are closest to the XOR node of the node to be synchronized to the routing table, where M is a predefined positive integer. The target node is a node in the routing table of the node to be synchronized that receives the node search request sent by the node to be synchronized.

For example, the node is queried by using a command: findnode (selfId, node) & findenode (0Xff . . . ff\hat{ }selfId, node). Regarding the number of closest nodes, M returned by the target node, a default value of the Kademelia protocol can be adopted, or can be customized by the user based on a corresponding command provided by the protocol, which is not limited in the present disclosure. Taking an existing Ethereum network as an example, M can take a value ranging from 10 to 100 of orders of magnitudes to obtain a better effect. As the number of network nodes and other operating conditions change, M can be adjusted as needed.

Node synchronization is performed according to a certain period. Therefore, the time used for this step in each synchronization is also limited. Therefore, once the node search request is sent, the timing can be performed; when the timing result reaches a first predefined time period, the sending of the node search request is stopped.

Afterwards, the information returned by each node in the routing table is acquired, and candidate nodes are determined according to the returned information. Since each queried node in the routing table returns information of 2M nodes, generally, the total number of returned nodes is larger than an upper limit value (i.e., 272) of the number of nodes in the local routing table.

FIG. 3 is a schematic diagram of a return result queried by a node in a routing table according to an embodiment of the present disclosure. The ordinate is the number of returned nodes, and the abscissa is time, in seconds. As can be seen from FIG. 3, at 161 seconds, more than 1,000 nodes have been returned.

These nodes can be used as candidate nodes, and further processing of the candidate nodes is described in detail below in combination with block S120.

In addition to querying the nodes of the routing table to obtain information of the plurality of first nodes adjacent to the node to be synchronized and information of the plurality of second nodes adjacent to the XOR node of the node to be synchronized, in some embodiments, the information of the plurality of first nodes adjacent to the node to be synchronized and the information of the plurality of second nodes adjacent to the XOR node of the node to be synchronized may also be obtained by mans of a global routing table including all nodes of the blockchain system and stored by the node to be synchronized.

Specifically, information of all nodes can be obtained from the global routing table including all nodes of the blockchain system and stored by the node to be synchronized. The global routing table includes: a node identifier, a node internet protocol address and current status information of each node of a blockchain network. Information of M first nodes closest to the node to be synchronized among all the nodes and information of M second nodes closest to the XOR node of the node to be synchronized are determined according to the information of all nodes, in which M is a predefined positive integer. The M first nodes closest to the node to be synchronized and the M second nodes closest to the XOR node of the node to be synchronized are determined as the candidate nodes.

The global routing table can be maintained by the node to be synchronized itself. In order to ensure timeliness and validity of its data, the global routing table is updated every second predefined time period to obtain latest node information.

Storing and maintaining the global routing table may bring additional storage and computing costs to the node, while obtaining adjacent nodes from the global routing table only requires a simple Boolean operation. It means that the synchronization stability can be acquired abnormal situations (such as the synchronization is slow) can be avoided at the expense of storage capacity and computing power. Compared with the returned data obtained by querying the routing table, since the adjacent nodes of the node to be synchronized (and its XOR node) are obtained from the global routing table, it is easier to obtain the optimal solution and stable update, and a waiting time for obtaining the returned data can be omitted.

A specific implementation can be selected according to the storage capacity, computing power of the node, with a comprehensive consideration of update efficiency and cost.

At block S120, a first predefined number of nodes are selected from the candidate nodes as new nodes.

A large number of candidate nodes can be obtained at block S110. However, if the node synchronization is performed according to all candidate nodes, it may cause consumption on memory and network ports and bandwidth. Therefore, pruning is required, such that some nodes are selected from all the candidate nodes as the new nodes of the routing table.

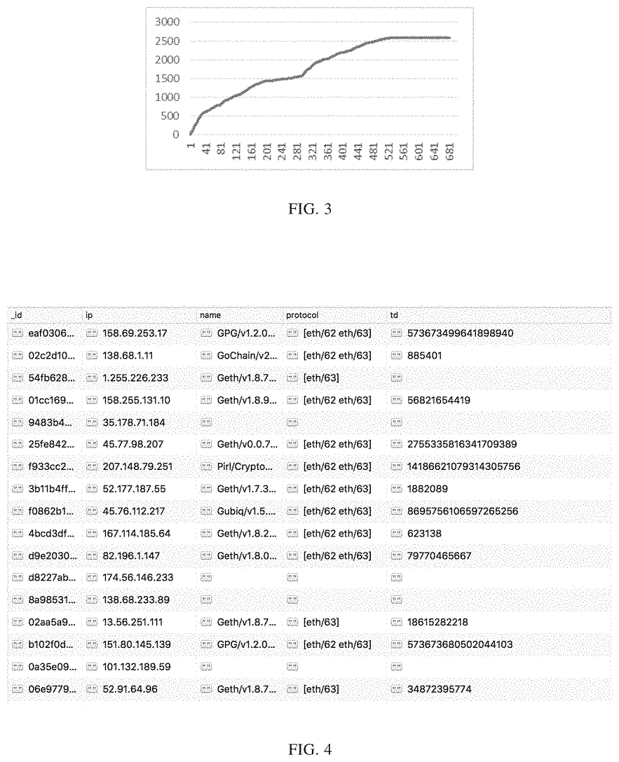

FIG. 4 is a schematic diagram of a selection of candidate nodes according to an embodiment of the present disclosure. FIG. 4 is a view of node information of the candidate nodes acquired by the node, which includes a node identifier (_ID), an Internet Protocol Address (IP), a node name (name), a protocol type (protocol) of each node, and a total difficulty value (TD) of the blockchain stored by each node.

According to the height of the blockchain of each node in the routing table, a plurality of nodes with the highest height can be kept in the routing table. Since the height of the blockchain is positively related to the total difficulty value of the blockchain (the total difficulty value of the blockchain is equal to a sum of difficulty values of all the blocks in the blockchain), the higher the height, the larger the TD value. Therefore, according to the total difficulty value of the blockchain stored in each candidate node, the first predefined number of nodes with the highest total difficulty value of the blockchain can be selected as the new nodes.

At block S130, a routing table of the node to be synchronized is updated according to information of the new nodes to obtain an updated routing table.

After obtaining the new nodes, the routing table of the node to be synchronized can be updated according to the new nodes. A specific update method of the routing table may be implemented according to related regulations about the update of buckets in the routing table in the Kademelia protocol and the DHT of the related art, which is not limited in the present disclosure.

At block S140, the node to be synchronized is synchronized according to the updated routing table.

The most direct way is to select a target synchronization node for synchronization according to the TD value of each node in the updated routing table. Specifically, the total difficulty value of the blockchain stored by each node in the updated routing table can be obtained, and the node with the highest total difficulty value of the blockchain can be determined as the target synchronization node, and then the blockchain data of the node to be synchronized can be updated according to the target synchronization node.

In some embodiments, other relevant factors may also be considered to select the target synchronization node for synchronization. For example, historical data of data throughput, historical data of synchronization success rate, and the total difficulty value of the blockchain of each node in the updated routing table of the node to be synchronized can be obtained. According to the historical data of data throughput, the historical data of synchronization success rate, and the total difficulty value of the blockchain, a credibility of each node in the routing table can be determined, and the target synchronization node for synchronization can be selected according to the credibility of each node. Therefore, according to the blockchain data stored by the target synchronization node, the blockchain data of the node to be synchronized is synchronized.

Compared with existing node updating methods, with the method for synchronizing blockchain nodes according to the present disclosure, more node information can be obtained, and the most ideal node can be selected from more nodes for synchronization and routing table update, thus the effect of synchronization reaches local optimum. In this way, the node may obtain currently confirmed or forked transactions faster and more stably, thereby ensuring the security and reliability of ledger records. Meanwhile, the routing table of the node is optimized.

In order to implement the method in the embodiments of the first aspect, embodiments of the second aspect of the present disclosure provide a device for synchronizing blockchain nodes.

The implementation of the device may include one or more computing devices. The computing device includes a processor and a memory, and the memory stores an application program including computer program instructions executable on the processor. The application program can be divided into a plurality of program modules for corresponding functions of each component of the system. The division of program modules is logical rather than physical. Each program module can run on one or more computing devices, and one computing device can also have one or more program modules running thereon. The system/device of the present disclosure is described in detail below according to the functional logic division of the program modules.

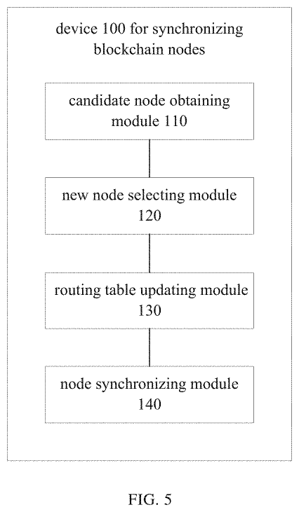

FIG. 5 is a block diagram of a device for synchronizing blockchain nodes according to an embodiment of the present disclosure. The device 100 for synchronizing blockchain nodes includes: a candidate node obtaining module 110, a new node selecting module 120, a routing table updating module 130, and a node synchronizing module 140.

The device 100 for synchronizing blockchain nodes can be implemented by using a computing device including a processor and a memory. The memory stores program modules that can be executed by the processor. When each program module is executed, the computing device can be controlled to implement the corresponding functions. For example, the device 100 according to the present disclosure may include the candidate node obtaining module 110, the new node selecting module 120, the routing table updating module 130, and the node synchronizing module 140, which can be implemented as such program modules.

The candidate node obtaining module 110 is configured to obtain information of a plurality of first nodes adjacent to a node to be synchronized, and information of a plurality of second nodes adjacent to an XOR node of the node to be synchronized, and determine candidate nodes according to the information of the plurality of first nodes and the information of the plurality of second nodes. The XOR node of the node to be synchronized refers to a node whose node identifier is an XOR value of a node identifier of the node to be synchronized.

In some embodiments, the candidate node obtaining module includes: a node searching unit, an information receiving unit, and a candidate node determining unit.

The node searching unit is configured to send a node search request to each node in the routing table of the node to be synchronized. the node search request comprises: requesting a target node to return information of M first nodes that are closest to the node to be synchronized to the routing table, and requesting the target node to return information of M second nodes that are closest to the XOR node of the node to be synchronized to the routing table, where M is a predefined positive integer.

The node searching unit is further configured to: start to time after sending the node search request; and in response to that a timing result reaches a first predefined time period, stop sending the node search request.

The information receiving unit is configured to obtain information returned by each node in the routing table.

The candidate node determining unit is configured to determine the candidate nodes according to the information returned by each node in the routing table.

In some embodiments, the device for synchronizing blockchain nodes further includes a global routing table, the global routing table comprises a node identifier, a node internet protocol address and current status information of each node of a blockchain network.

The candidate node obtaining module includes: a global node obtaining unit, an adjacent node computing unit and a candidate node determining unit.

The global node obtaining unit is configured to obtain information of all nodes from the global routing table.

The adjacent node computing unit is configured to determine information of M first nodes closest to the node to be synchronized among all the nodes, and information of M second nodes closest to the XOR node of the node to be synchronized according to the information of all nodes, where M is a predefined positive integer.

The candidate node determining unit is configured to determine the M first nodes closest to the node to be synchronized and the M second nodes closest to the XOR node of the node to be synchronized as the candidate nodes.

The device for synchronizing blockchain nodes further includes: a global routing table updating module, configured to update the global routing table every second predefined time period to obtain latest node information.

The new node selecting module 120 selects the first predefined number of nodes from the candidate nodes as the new nodes, by: according to a total difficulty value of a blockchain stored in each candidate node, selecting the first predefined number of nodes each with the highest total difficulty value as the new nodes.

The routing table updating module 130 is configured to update the routing table of the node to be synchronized according to the information of the new nodes to obtain an updated routing table.

The node synchronizing module 140 is configured to synchronize the node to be synchronized according to the updated routing table.

The node synchronizing module 140 synchronizes the node to be synchronized according to the updated routing table, by: obtaining a total difficulty value of a blockchain stored in each node of the updated routing table; determining a node with a highest total difficulty value as a target synchronization node; and synchronizing blockchain data of the node to be synchronized according to the target synchronization node.

For details of functions of each module in the device for synchronizing blockchain nodes according to the disclosure and the implementation of the functions, reference can be made to the implementation of the corresponding steps in the above method. As for the device embodiments, which basically correspond to the method embodiments, the foregoing explanation of the method embodiments of the present disclosure is also applicable to the device embodiments of the present disclosure. In order to avoid redundancy, all details will not be repeated in the device embodiments. For unmentioned details, please refer to the above description of the embodiments of the method for synchronizing blockchain nodes with reference to FIG. 1 to FIG. 4.

Compared with existing node updating modes, with the device for synchronizing blockchain nodes according to the present disclosure, more node information can be obtained, and the most ideal node can be selected from more nodes for synchronization and routing table update, thus the effect of synchronization reaches local optimum. In this way, the node may obtain currently confirmed or forked transactions faster and more stably, thereby ensuring the security and reliability of ledger records. Meanwhile, the routing table of the node is optimized.

Embodiments of the third aspect of the present disclosure provide a non-transitory computer-readable storage medium having executable instructions stored thereon, and when the executable instructions are run on a processor, the method for synchronizing blockchain nodes according to embodiments of the first aspect is implemented. The storage medium may be provided on the device as a part of the device; or when the device can be remotely controlled by a server, the storage medium may be provided on a remote server that controls the device.

The computer instructions used to implement the method of the present disclosure may be carried in any combination of one or more computer-readable mediums. The so-called non-transitory computer-readable medium may include any computer-readable medium, except for the signal itself which is temporarily propagated. The computer-readable storage medium may include, but is not limited to, an electronic, magnetic, optical, electromagnetic, infrared, or semiconductor system, apparatus, or device, or any suitable combination of the foregoing. More specific examples (not exhaustive) of computer-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing. In the present disclosure, a computer-readable storage medium may be any tangible medium that contains or stores a program that can be used by or in combination with an instruction execution system, apparatus, or device.

Embodiments of the fourth aspect of the present disclosure provide a computer program product, when instructions in the computer program product are executed by a processor, the method for synchronizing blockchain nodes according to embodiments of the first aspect is implemented.

The computer program code for carrying out operations of embodiments of the present disclosure may be written in one or more programming languages. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer through any kind of network, including a Local Area Network (hereafter referred as to LAN) or a Wide Area Network (hereafter referred as to WAN), or connected to an external computer (such as using an Internet service provider through the Internet).

Embodiments of the fifth aspect of the present disclosure provide a computing device including a memory, a processor, and a computer program stored on the memory and executable on the processor. When the program is executed by the processor, the method for synchronizing blockchain nodes according to embodiments of the first aspect is implemented.

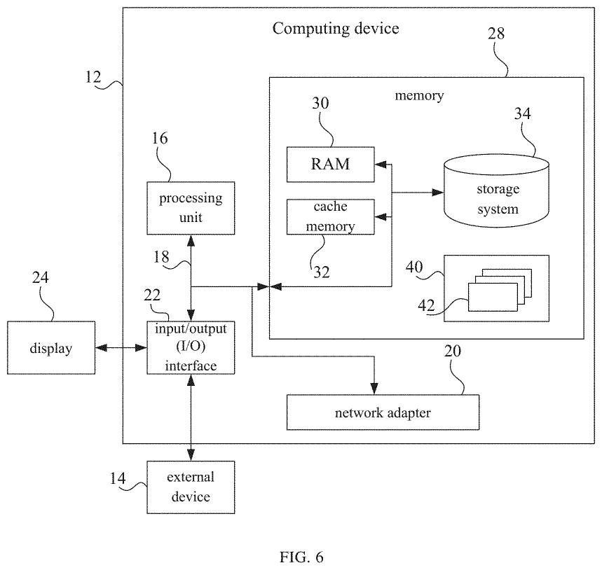

FIG. 6 is a schematic diagram of an exemplary computing device according to an embodiment of the present disclosure. The computing device 12 illustrated in FIG. 6 is merely an example and should not impose any limitation on the functions and scope of use of the embodiments of the present disclosure.

As illustrated in FIG. 6, the computing device 12 is in the form of a general-purpose computing apparatus. The computing device 12 may include, but is not limited to, one or more processors or processing units 16, a system memory 28, and a bus 18 connecting different system components (including the system memory 28 and the processing unit 16).

The bus 18 represents one or more of several types of bus architectures, including a memory bus or a memory control bus, a peripheral bus, a graphic acceleration port (GAP) bus, a processor bus, or a local bus using any bus architecture in a variety of bus architectures. For example, these architectures include, but are not limited to, an industry standard architecture (ISA) bus, a micro-channel architecture (MCA) bus, an enhanced ISA bus, a video electronic standards association (VESA) local bus, and a peripheral component interconnect (PCI) bus.

Typically, the computing device 12 may include multiple kinds of computer-readable media. These media may be any storage media accessible by the computing device 12, including transitory or non-transitory storage medium and movable or unmovable storage medium.

The memory 28 may include a computer-readable medium in a form of volatile memory, such as a random access memory (RAM) 30 and/or a high-speed cache memory 32. The computing device 12 may further include other transitory/non-transitory storage media and movable/unmovable storage media. In way of example only, the storage system 34 may be used to read and write non-removable, non-volatile magnetic media (not shown in the figure, commonly referred to as “hard disk drives”). Although not illustrated in FIG. 6, it may be provided a disk driver for reading and writing movable non-volatile magnetic disks (e.g. “floppy disks”), as well as an optical driver for reading and writing movable non-volatile optical disks (e.g. a compact disc read only memory (CD-ROM, a digital video disc read only Memory (DVD-ROM), or other optical media). In these cases, each driver may be connected to the bus 18 via one or more data medium interfaces. The memory 28 may include at least one program product, which has a set of (for example at least one) program modules configured to perform the functions of embodiments of the present disclosure.

A program/application 40 with a set of (at least one) program modules 42 may be stored in memory 28, the program modules 42 may include, but not limit to, an operating system, one or more application programs, other program modules and program data, and any one or combination of above examples may include an implementation in a network environment. The program modules 42 are generally configured to implement functions and/or methods described in embodiments of the present disclosure.

The computing device 12 may also communicate with one or more external devices 14 (e.g., a keyboard, a pointing device, a display 24, and etc.) and may also communicate with one or more devices that enables a user to interact with the computer system/server 12, and/or any device (e.g., a network card, a modem, and etc.) that enables the computer system/server 12 to communicate with one or more other computing devices. This kind of communication can be achieved by the input/output (I/O) interface 22. In addition, the device 12 may be connected to and communicate with one or more networks such as a local area network (LAN), a wide area network (WAN) and/or a public network such as the Internet through a network adapter 20. As shown, the network adapter 20 communicates with other modules of the device 12 over bus 18. It should be understood that although not shown in FIG. 6, other hardware and/or software modules may be used in combination with the device 12, which including, but not limited to, microcode, device drivers, redundant processing units, external disk drive arrays, RAID systems, tape drives, as well as data backup storage systems and the like.

The processing unit 16 can perform various functional applications and data processing by running programs stored in the system memory 28, for example, to perform the quality evaluating method provided by embodiments of the present disclosure.

The non-transitory computer-readable storage medium, the computer program product, and the computing device according to embodiments of the third to fifth aspects of the present disclosure can be implemented with reference to the content specifically described in the embodiment of the first aspect of the present disclosure, and have similar beneficial effects as the method for synchronizing blockchain nodes based on a trust mechanism, which is not repeated here.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations for example, the order of execution may differ from that which is depicted, or the order of execution of two or more boxes shown in succession in the flow chart may be executed concurrently or with partial concurrence, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

1. A method for synchronizing blockchain nodes, comprising:
obtaining information of a plurality of first nodes adjacent to a node to be synchronized, and information of a plurality of second nodes adjacent to an XOR node of the node to be synchronized, and determining candidate nodes according to the information of the plurality of first nodes and the information of the plurality of second nodes, wherein the XOR node of the node to be synchronized refers to a node whose node identifier is an XOR value of a node identifier of the node to be synchronized;
selecting a first predefined number of nodes from the candidate nodes as new nodes;
updating a routing table of the node to be synchronized according to information of the new nodes to obtain an updated routing table; and
synchronizing the node to be synchronized according to the updated routing table.

2. The method according to claim 1, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
sending a node search request to each node in the routing table of the node to be synchronized, wherein the node search request comprises: requesting a target node to return information of M first nodes closest to the node to be synchronized to the routing table, and requesting the target node to return information of M second nodes closest to the XOR node of the node to be synchronized to the routing table, where M is a predefined positive integer;
obtaining information returned by each node in the routing table; and
determining the candidate nodes according to the information returned by each node in the routing table.

3. The method according to claim 2, wherein sending the node search request to each node in the routing table of the node to be synchronized, comprises:
starting to time after sending the node search request; and
in response to that a timing result reaches a first predefined time period, stopping sending the node search request.

4. The method according to claim 1, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
obtaining information of all nodes from a global routing table containing all nodes of a blockchain system and stored by the node to be synchronized, wherein the global routing table comprises a node identifier, a node internet protocol address and current status information of each node of a blockchain network;
determining information of M first nodes closest to the node to be synchronized among all the nodes, and information of M second nodes closest to the XOR node of the node to be synchronized according to the information of all nodes, where M is a predefined positive integer; and
determining the M first nodes closest to the node to be synchronized and the M second nodes closest to the XOR node of the node to be synchronized as the candidate nodes.

5. The method according to claim 4, comprising:
updating the global routing table every second predefined time period to obtain latest node information.

6. The method according to claim 1, wherein selecting the first predefined number of nodes from the candidate nodes as the new nodes, comprises:
according to a total difficulty value of a blockchain stored in each candidate node, selecting the first predefined number of nodes each with a highest total difficulty value as the new nodes.

7. The method according to claim 1, wherein synchronizing the node to be synchronized according to the updated routing table, comprises:
obtaining a total difficulty value of a blockchain stored in each node of the updated routing table;
determining a node with a highest total difficulty value as a target synchronization node; and
synchronizing blockchain data of the node to be synchronized according to the target synchronization node.

8.-14. (canceled)

15. A non-transitory computer-readable storage medium having a computer program stored thereon, wherein when the program is executed by a processor, the processor is caused to implement a method for synchronizing blockchain nodes comprising:
obtaining information of a plurality of first nodes adjacent to a node to be synchronized, and information of a plurality of second nodes adjacent to an XOR node of the node to be synchronized, and determining candidate nodes according to the information of the plurality of first nodes and the information of the plurality of second nodes, wherein the XOR node of the node to be synchronized refers to a node whose node identifier is an XOR value of a node identifier of the node to be synchronized;
selecting a first predefined number of nodes from the candidate nodes as new nodes;
updating a routing table of the node to be synchronized according to information of the new nodes to obtain an updated routing table; and
synchronizing the node to be synchronized according to the updated routing table.

16. (canceled)

17. A computing device, comprising a memory, a processor, and a computer program stored on the memory and executable on the processor, wherein when the program is executed by the processor, the processor is caused to implement a method for synchronizing blockchain nodes comprising:
obtaining information of a plurality of first nodes adjacent to a node to be synchronized, and information of a plurality of second nodes adjacent to an XOR node of the node to be synchronized, and determining candidate nodes according to the information of the plurality of first nodes and the information of the plurality of second nodes, wherein the XOR node of the node to be synchronized refers to a node whose node identifier is an XOR value of a node identifier of the node to be synchronized;
selecting a first predefined number of nodes from the candidate nodes as new nodes;
updating a routing table of the node to be synchronized according to information of the new nodes to obtain an updated routing table; and
synchronizing the node to be synchronized according to the updated routing table.

18. The non-transitory computer-readable storage medium according to claim 15, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
sending a node search request to each node in the routing table of the node to be synchronized, wherein the node search request comprises: requesting a target node to return information of M first nodes closest to the node to be synchronized to the routing table, and requesting the target node to return information of M second nodes closest to the XOR node of the node to be synchronized to the routing table, where M is a predefined positive integer;
obtaining information returned by each node in the routing table; and
determining the candidate nodes according to the information returned by each node in the routing table.

19. The non-transitory computer-readable storage medium according to claim 18, wherein sending the node search request to each node in the routing table of the node to be synchronized, comprises:
starting to time after sending the node search request; and
in response to that a timing result reaches a first predefined time period, stopping sending the node search request.

20. The non-transitory computer-readable storage medium according to claim 15, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
obtaining information of all nodes from a global routing table containing all nodes of a blockchain system and stored by the node to be synchronized, wherein the global routing table comprises a node identifier, a node internet protocol address and current status information of each node of a blockchain network;
determining information of M first nodes closest to the node to be synchronized among all the nodes, and information of M second nodes closest to the XOR node of the node to be synchronized according to the information of all nodes, where M is a predefined positive integer; and
determining the M first nodes closest to the node to be synchronized and the M second nodes closest to the XOR node of the node to be synchronized as the candidate nodes.

21. The non-transitory computer-readable storage medium according to claim 20, the method further comprising:
updating the global routing table every second predefined time period to obtain latest node information.

22. The non-transitory computer-readable storage medium according to claim 15, wherein selecting the first predefined number of nodes from the candidate nodes as the new nodes, comprises:
according to a total difficulty value of a blockchain stored in each candidate node, selecting the first predefined number of nodes each with a highest total difficulty value as the new nodes.

23. The non-transitory computer-readable storage medium according to claim 15, wherein synchronizing the node to be synchronized according to the updated routing table, comprises:
obtaining a total difficulty value of a blockchain stored in each node of the updated routing table;
determining a node with a highest total difficulty value as a target synchronization node; and
synchronizing blockchain data of the node to be synchronized according to the target synchronization node.

24. The computing device according to claim 17, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
sending a node search request to each node in the routing table of the node to be synchronized, wherein the node search request comprises: requesting a target node to return information of M first nodes closest to the node to be synchronized to the routing table, and requesting the target node to return information of M second nodes closest to the XOR node of the node to be synchronized to the routing table, where M is a predefined positive integer;
obtaining information returned by each node in the routing table; and
determining the candidate nodes according to the information returned by each node in the routing table.

25. The computing device according to claim 24, wherein sending the node search request to each node in the routing table of the node to be synchronized, comprises:
starting to time after sending the node search request; and
in response to that a timing result reaches a first predefined time period, stopping sending the node search request.

26. The computing device according to claim 17, wherein obtaining the information of the plurality of first nodes adjacent to the node to be synchronized and the information of the plurality of second nodes adjacent to the XOR node of the node to be synchronized, and determining the candidate nodes according to the information of the plurality of first nodes and the information of the plurality of second nodes, comprises:
obtaining information of all nodes from a global routing table containing all nodes of a blockchain system and stored by the node to be synchronized, wherein the global routing table comprises a node identifier, a node internet protocol address and current status information of each node of a blockchain network;
determining information of M first nodes closest to the node to be synchronized among all the nodes, and information of M second nodes closest to the XOR node of the node to be synchronized according to the information of all nodes, where M is a predefined positive integer; and
determining the M first nodes closest to the node to be synchronized and the M second nodes closest to the XOR node of the node to be synchronized as the candidate nodes.

27. The computing device according to claim 26, the method further comprising:
updating the global routing table every second predefined time period to obtain latest node information.

28. The computing device according to claim 17, wherein selecting the first predefined number of nodes from the candidate nodes as the new nodes, comprises:
according to a total difficulty value of a blockchain stored in each candidate node, selecting the first predefined number of nodes each with a highest total difficulty value as the new nodes.

29. The computing device according to claim 17, wherein synchronizing the node to be synchronized according to the updated routing table, comprises:
obtaining a total difficulty value of a blockchain stored in each node of the updated routing table;
determining a node with a highest total difficulty value as a target synchronization node; and
synchronizing blockchain data of the node to be synchronized according to the target synchronization node.
